(19) United States
(12) Patent Application Publication
(10) Pub. No.: US 2011/0295885 A1
(43) Pub. Date: Dec. 1, 2011

(54) REMOTE-INTERACTION APPARATUS AND INTERACTION UNIT THEREOF

(75) Inventors: Shyh-Yi JAN, Jungjeng Chiu (TW); Shih-Ting SIAO, Jungjeng Chiu (TW); Tun-Hao YOU, Jungjeng Chiu (TW); Chen-Yu WANG, Jungjeng Chiu (TW); Chien-Ping WU, Jungjeng Chiu (TW)

(73) Assignee: RawLaro Studio Co., LTD., Taipei City (TW)

(21) Appl. No.: 13/115,067

(22) Filed: May 24, 2011

(30) Foreign Application Priority Data
May 26, 2010 (TW) 099116891

(51) Int. Cl. G06F 17/30

(52) U.S. Cl. 707/769; 707/E17.014

(57) ABSTRACT

A remote-interaction apparatus comprises a portable electronic device installing a specific software and an interaction unit having an interaction-mode database. The interaction unit can detect a sensory information inputted by a user and find out an interaction information corresponding to the sensory information from the interaction-mode database for transmitting the first interaction information to the portable electronic device by a first communication protocol. And the specific software employs the portable electronic device to transmit the interaction information to another remote-interaction apparatus by a second communication protocol. The specific software can also employ the portable electronic device to transmit another interaction information transmitted from the said another remote-interaction apparatus to the interaction unit by the first communication protocol, so that the interaction unit can find out a control command corresponding to the said another interaction information from the interaction-mode database and perform a response action according to the control command.

### FIELD OF THE INVENTION

The present invention relates to a remote-interaction apparatus and an interaction unit thereof, and more particularly to a remote-interaction apparatus using a portable electronic device as a communication media for interacting information and an interaction unit thereof.

### BACKGROUND OF THE INVENTION

With the rapid development of the communication technology, people can transmit information to remote friend or family via telephone network, wireless communication network and international network. For example, when a traveler misses his/her family at hometown, he/she can use a mobile phone to talk with his/her family or use a computer to send e-mails to his/her family via the international network, etc. Therefore, the emotional communication among people is not limited by distance in space.

However, emotions of people are very subtle, and it is poor to express the subtle emotions by transmitting the emotions via the conventional media such as the telephones or the e-mails. In addition, it also lacks the diversity and the interest to express the emotions by transmitting the emotions via the conventional media such as the telephones or the e-mails. Furthermore, to express the emotions by the conventional mode via the conventional media is also difficult to deeply move the soul of the opposite people.

### SUMMARY OF THE INVENTION

The present invention relates to a remote-interaction apparatus which can express an emotion of a user in remote distance.

The present invention also relates to an interaction unit adapted to the remote-interaction apparatus.

The present invention provides a remote-interaction apparatus, which comprises a portable electronic device and an interaction unit. A specific software is installed in the portable electronic device. The interaction unit has an interaction-mode database. The interaction unit is used for communicating with the portable electronic device by a first communication protocol. And the interaction unit is configured for detecting a sensory information inputted by a user and finding out a first interaction information corresponding to the sensory information from the interaction-mode database for transmitting the first interaction information to the portable electronic device by the first communication protocol, so that the specific software can employ the portable electronic device to transmit the first interaction information to a portable electronic device of another remote-interaction apparatus by a second communication protocol. The specific software can also employ the portable electronic device to transmit a second interaction information transmitted from the said another remote-interaction apparatus to the interaction unit by the first communication protocol, so that the interaction unit can find out a control command corresponding to the second interaction information from the interaction-mode database and perform a response action according to the control command.

The present invention also provides an interaction unit adapted to the remote-interaction apparatus. The interaction unit comprises a process unit. The communication module is configured for communicating with the portable electronic device by a first communication protocol. The input interface is configured for detecting a sensory information inputted by a user. The response module is configured for performing a response action according to a control command. The process unit is configured for finding out a first interaction information corresponding to the sensory information from an interaction-mode database and employing the first communication protocol for transmitting the first interaction information to the portable electronic device through the communication module, so that the specific software can employ the portable electronic device to transmit the first interaction information to a portable electronic device of another remote-interaction apparatus by a second communication protocol. The process unit is further configured for employing the first communication protocol to receive a second interaction information transmitted from the portable electronic device through the communication module. The second interaction information is provided from the said another remote-interaction apparatus. The process unit is further configured for finding out the control command corresponding to the second interaction information from the interaction-mode database and transmitting the control command to the response module.

In an exemplary embodiment of the present invention, the response module comprises at least one of a light-emitting device, a display device, a sound-making device, a vibration device and an odor-diffusion device, and the response action comprises at least one of emitting light, displaying image, making sound, vibrating and diffusing odor. sensory information comprises at least one of action, body-temperature, sound, touch, response, taste and appearance of the user.

In an exemplary embodiment of the present invention, the communication module comprises at least one of a Universal Series Bus module, a RS232 module, a radio frequency transceiving module, a far infrared module, a wireless fidelity module, a Bluetooth module, a ZigBee module and a power line communication module.

In an exemplary embodiment of the present invention, the interaction unit further comprises a memory, and the interaction-mode database is stored in the memory.

In an exemplary embodiment of the present invention, the portable electronic device comprises one of a mobile phone, a personal digital assistant, a notebook computer, a netbook computer, a tablet computer, a mobile internet device, an E-book and a mobile multimedia device.

In an exemplary embodiment of the present invention, the second communication protocol comprises one of a wireless communication protocol and an internet communication protocol.

The present invention employs the portable electronic device installing the specific software and the interaction unit having the interaction-mode database to construct the remote-interaction apparatus, and the remote-interaction apparatus uses the portable electronic device as a media for transmitting the interaction information. In actual design, the interaction unit can detect the sensory information inputted by a user and find out an interaction information corresponding to the sensory information from the interaction-mode database, so as to transmit the interaction information to the portable electronic device by the first portable electronic device to transmit the interaction information to another remote-interaction apparatus by the second communication protocol. In addition, the specific software can employ the portable electronic device to transmit another interaction information transmitted from another remote-interaction apparatus to the interaction unit, so that the interaction unit can find out a control command corresponding to the interaction information from the interaction-mode database and perform a response action according to the control command. From the above design, the interaction operation between two remote-interaction apparatuses can be performed, and the subtle emotions of people can be expressed by the interaction operation.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic view for showing two remote-interaction apparatuses in accordance with an exemplary embodiment of the present invention.

FIG. 2 is a schematic view of an interaction unit in accordance with an exemplary embodiment of the present invention.

FIG. 3 is a schematic view of a response module in accordance with an exemplary embodiment of the present invention.

FIG. 4 is a schematic view of a communication module in accordance with an exemplary embodiment of the present invention.

FIG. 5 is a schematic view of a remote-interaction apparatus in accordance with another exemplary embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

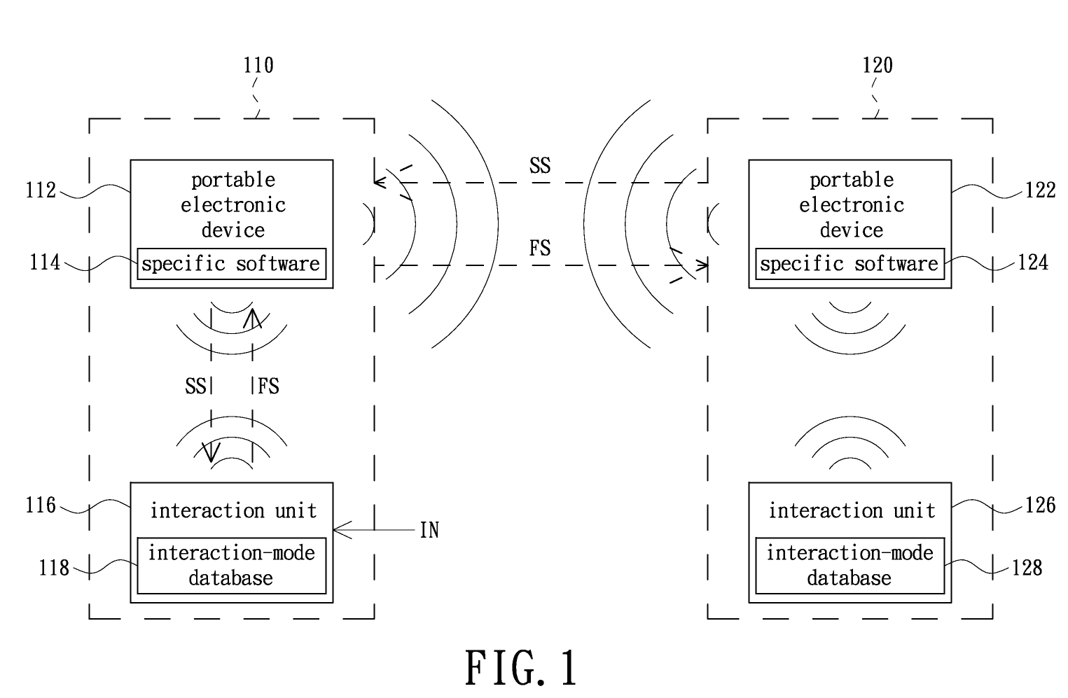

FIG. 1 is a schematic view for showing two remote-interaction apparatuses in accordance with an exemplary embodiment of the present invention. In FIG. 1, labels 110 and 120 both represent remote-interaction apparatuses. As shown in FIG. 1, the remote-interaction apparatus 110 comprises a portable electronic device 112 and an interaction unit 116. A specific software 114 is installed in the portable electronic device 112, and the interaction unit 116 has an interaction-mode database 118. Similarly, the remote-interaction apparatus 120 comprises a portable electronic device 122 and an interaction unit 126. A specific software 124 is installed in the portable electronic device 122, and the interaction unit 126 has an interaction-mode database 128.

In the exemplary embodiment, the portable electronic devices 112 and 122 can be a mobile phone respectively, and the two portable electronic devices can download the specific software from the internet. Of course, the specific software can be installed in the two portable electronic devices in advance when manufacturing. The present invention is not limited herein. In addition, in the exemplary embodiment, the two specific softwares 114 and 124 have the same content, and the two interaction-mode databases 118 and 128 have the same content, but the present invention is not limited herein. The apparatuses communicating with each other.

Taking the remote-interaction apparatus 110 as an example, the interaction unit 116 of the remote-interaction apparatus 110 can transmit/receive information to/from the portable electronic device 112 by a first communication protocol. The first communication protocol can be the Bluetooth communication protocol (which is widely used in mobile phones), the near field communication (NFC protocol) and so on. The interaction unit 116 is further configured for detecting sensory information IN inputted by a user, such as touch strength, touch time or touch frequency of the user touching the interaction unit 116. The interaction unit 116 finds out a first interaction information FS corresponding to the sensory information IN from the interaction-mode database 118 after it detects the sensory information IN inputted by the user, and the interaction unit 116 transmits the first interaction information FS to the portable electronic device 112 by the first communication protocol.

Thereafter, the specific software 114 employs the portable electronic device 112 to transmit the first interaction information FS to the portable electronic device 122 of the remote-interaction apparatus 120 by a second communication protocol after it detects the portable electronic device 112 receives the first interaction information FS. In the exemplary embodiment, the second communication protocol is the wireless communication protocol permanently used in the mobile phone. In addition, the specific software 114 can further employ the portable electronic device 112 to transmit a second interaction information SS transmitted from the remote-interaction apparatus 120 to the interaction unit 116 by the first communication protocol. Thus, the interaction unit 116 can find out a control command corresponding to the second to perform a response action (i.e., emitting light) according to the control command.

In the exemplary embodiment, the interaction units 116 and 126 can be integrated with two photo frames respectively. Therefore, when a traveler carrying the remote-interaction apparatus 110 misses his/her family at hometown and touches the photo frame with the interaction unit 116, the interaction unit 116 can detect the sensory information such as the touch strength, the touch time or the touch frequency, and then the interaction unit 116 can convert the sensory information into a corresponding interaction information, so as to use the portable electronic device 112 (e.g., a mobile phone) as a media for transmitting the interaction information, so that the interaction information can be transmitted to the remote-interaction apparatus 120 carried by the family of the traveler. Thus, the interaction unit 126 of the remote-interaction apparatus 120 can emit the light according to the interaction information. Therefore, when the family of the traveler notes that the photo frame with the interaction unit 126 emits light, he/she will be aware that the traveler is missing him/her. Similarly, when the traveler notes that the photo frame with the interaction unit 116 emits light, the traveler will be aware that his/her family is missing him/her.

It should be noted that the interaction units 116 and 126 can be designed to synchronously perform a specific response action when they are synchronously touched. For example, the interaction units 116 and 126 can synchronously emit light according to the control command.

Although the portable electronic devices 112 and 122 are implemented by two mobile phones in the above description, the portable electronic devices 112 and 122 can also be performed by personal digital computers (e.g., iPads, Android pads or other tablet devices), mobile internet devices (MIDs), E-books or mobile multimedia devices, and so on. Furthermore, the present invention does not limit that the two portable electronic devices must be implemented by the same electronic device. In addition, the second communication protocol is not limited in the wireless communication protocol (e.g., GSM protocol, CDMA protocol, PHS protocol, WCDMA protocol or other cellular data communication protocol), and it also can be the internet communication protocol.

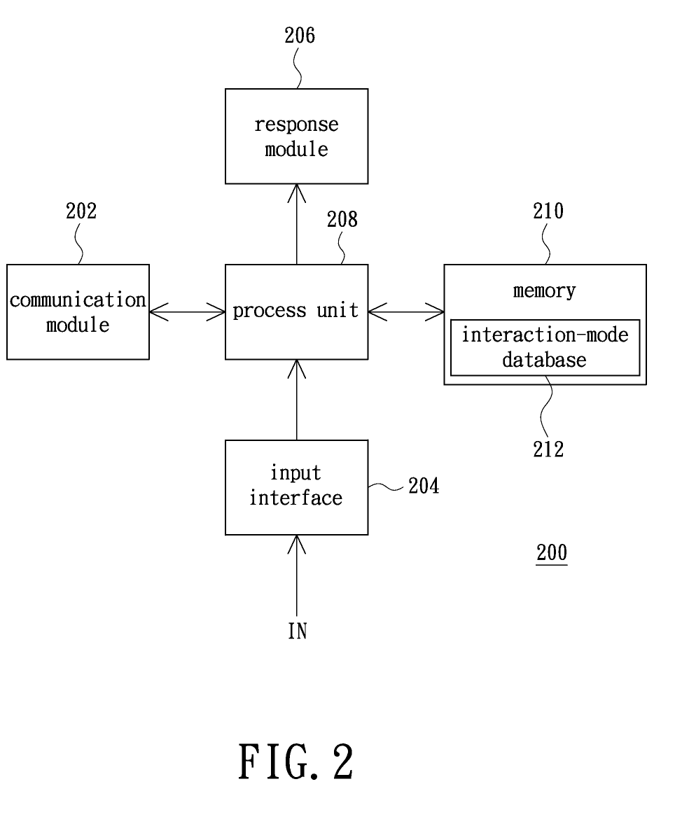

The following will further describe the interaction units 116 and 126 in detail. FIG. 2 is a schematic view of an interaction unit in accordance with an exemplary embodiment of the present invention. As shown in FIG. 2, the interaction unit 200 comprises a communication module 202, an input interface 204, a response module 206, a process unit 208 and a memory 210. The communication module 202 is configured for transmitting/receiving the information to/from the portable electronic device by the first communication protocol. The input interface 204 is configured for detecting the sensory information IN inputted by the user. The response module 206 is configured for performing the response action according to the control command. The process unit 208 is configured for finding out the first interaction information corresponding to the sensory information IN from the interaction-mode database 212 in the memory 210, so as to use the first communication protocol to transmit the first interaction information to the portable electronic device through the communication module 202. In addition, the process unit 208 further uses the first communication protocol to receive the second interaction information from the portable electronic device through the communication module 202, so as to find out the control command from the response module 206.

Although the interaction unit 200 shown in FIG. 2 employs the memory 210 to store the interaction-mode database 212, the interaction-mode database 212 can also be stored in an original memory space of the process unit 208 to omit the memory 210.

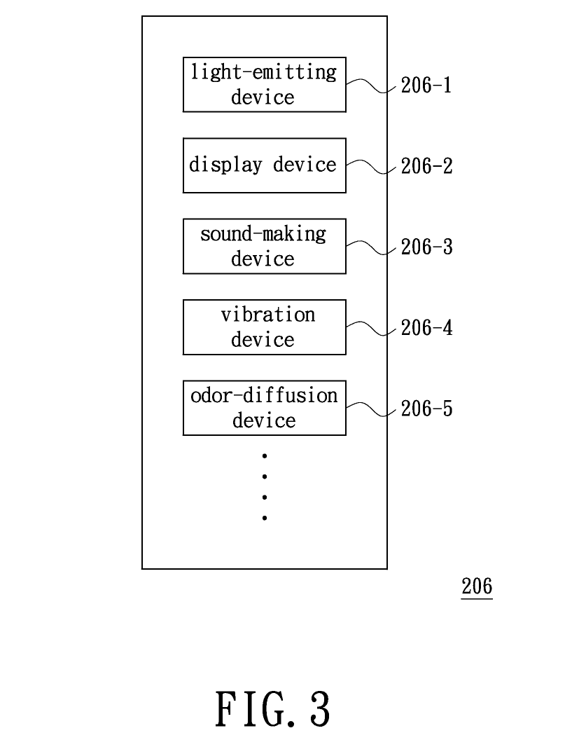

In addition, it can be seen from FIG. 1 that the response action performed by the response module 206 is not limited to emit light. In fact, the response action performed by the response module 206 can be consisted of a plurality of actions with different attributes such as emitting light, making sound, etc. That is, the response module 206 can comprises a plurality of devices for performing a plurality of actions with different attributes. FIG. 3 is a schematic view of a response module in accordance with an exemplary embodiment of the present invention. As shown in FIG. 3, the response module 206 comprises a light-emitting device 206-1, a display device 206-2, a sound-making device 206-3, a vibration device 206-4, an odor-diffusion device 206-5, and so on. Thus, the response action performed by the response module 206 can comprises the actions with different attributes, such as emitting light, displaying image, making sound, vibrating, diffusing odor, etc.

Furthermore, it can be seen from FIG. 1 that the input interface 204 is not limited to detect the touch strength, the touch time or the touch frequency of the user touching the interaction unit 200. The input interface 204 can also include different modes, so that the input interface 204 can detect the sensory information IN with a plurality of different attributes. In other words, the input interface 204 can be designed to detect the sensory information IN such as action, body-temperature, sound, touch, response, taste and appearance of the user. Therefore, the sensory information IN can comprise at least one of the action, the body-temperature, the sound, the touch, the response, the taste and the appearance of the user.

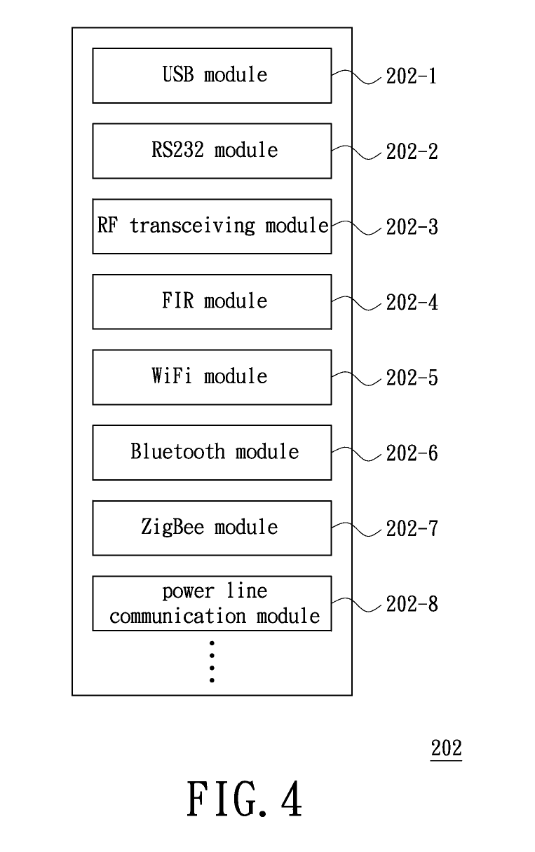

In addition, the above description related to FIG. 1 has described that the first communication protocol is not limited in the Bluetooth communication protocol, thus it is understood for persons skilled in the art that the communication module 202 can integrate a plurality of communication devices. FIG. 4 is a schematic view of a communication module in accordance with an exemplary embodiment of the present invention. As shown in FIG. 4, the communication module 202 can comprise a Universal Series Bus (USB) module 202-1, a RS232 module 202-2, a radio frequency (RF) transceiving module 202-3, a far infrared (FIR) module 202-4, a wireless fidelity (WiFi) module 202-5, a Bluetooth module 202-6, a ZigBee module 202-7 and a power line communication module 202-8, etc.

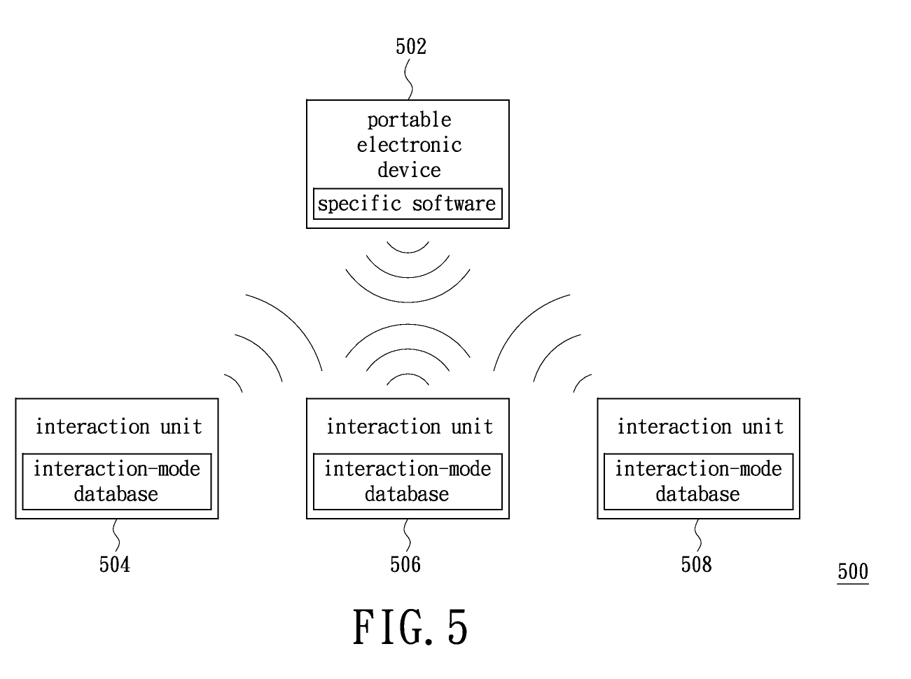

From the description of the above exemplary embodiments, it is understood for persons skilled in the art that the present invention can be performed by cooperating a portable electronic device with a plurality of interaction units. FIG. 5 is a schematic view of a remote-interaction apparatus in accordance with another exemplary embodiment of the present invention. As shown in FIG. 5, the remote-interaction apparatus 500 comprises a portable electronic device 502 and three interaction units which are labeled by 504, 506 and 508 respectively. Each of the interaction units can communicate with the portable electronic device 502 by the first communication protocol, and the first communication protocol can be the ZigBee communication protocol.

In summary, the present invention employs the portable electronic device installing the specific software and the interaction unit apparatus, and the remote-interaction apparatus uses the portable electronic device as a media for transmitting the interaction information. In actual design, the interaction unit can detect the sensory information inputted by the user, and find out an interaction information corresponding to the sensory information from the interaction-mode database, so as to transmit the interaction information to the portable electronic device by the first communication protocol. Then, the specific software can employ the portable electronic device to transmit the interaction information to another remote-interaction apparatus by the second communication protocol. In addition, the specific software can employ the portable electronic device to transmit another interaction information transmitted from another remote-interaction apparatus to the interaction unit, so that the interaction unit can find out a control command corresponding to the interaction information from the interaction-mode database and perform a response action according to the control command. From the above design, the interaction operation between two remote-interaction apparatuses can be performed, and the subtle emotions of people can be expressed by the interaction operation.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A remote-interaction apparatus, comprising:
a portable electronic device installing a specific software; and
an interaction unit having an interaction-mode database, the interaction unit being used for communicating with the portable electronic device by a first communication protocol;
wherein the interaction unit is configured for detecting a sensory information inputted by a user and finding out a first interaction information corresponding to the sensory information from the interaction-mode database for transmitting the first interaction information to the portable electronic device by the first communication protocol, so that the specific software can employ the portable electronic device to transmit the first interaction information to a portable electronic device of another remote-interaction apparatus by a second communication protocol, the specific software can also employ the portable electronic device to transmit a second interaction information transmitted from the said another remote-interaction apparatus to the interaction unit by the first communication protocol, so that the interaction unit can find out a control command corresponding to the second interaction information from the interaction-mode database and perform a response action according to the control command.

2. The remote-interaction apparatus according to claim 1, wherein the interaction unit comprises:
a communication module configured for being used for communicating with the portable electronic device by the first
an input interface configured for detecting the sensory information inputted by the user;
a response module configured for performing the response action according to the control command; and
a process unit configured for finding out the first interaction information corresponding to the sensory information from the interaction-mode database, so as to employ the first communication protocol for transmitting the first interaction information to the portable electronic device through the communication module, the process unit being further configured for employing the first communication protocol to receive the second interaction information transmitted from the portable electronic device through the communication module, so as to find out the control command from the interaction-mode database and transmit the control command to the response module.

3. The remote-interaction apparatus according to claim 2, wherein the response module comprises at least one of a light-emitting device, a display device, a sound-making device, a vibration device and an odor-diffusion device, and the response action comprises at least one of emitting light, displaying image, making sound, vibrating and diffusing odor.

4. The remote-interaction apparatus according to claim 2, wherein the sensory information comprises at least one of action, body-temperature, sound, touch, response, taste and appearance of the user.

5. The remote-interaction apparatus according to claim 2, wherein the communication module comprises at least one of a Universal Series Bus module, a RS232 module, a radio frequency transceiving module, a far infrared module, a wireless fidelity module, a Bluetooth module, a ZigBee module and a power line communication module.

6. The remote-interaction apparatus according to claim 2, wherein the interaction unit further comprises a memory, and the interaction-mode database is stored in the memory.

7. The remote-interaction apparatus according to claim 1, wherein the portable electronic device comprises one of a mobile phone, a personal digital assistant, a notebook computer, a netbook computer, a tablet computer, a mobile internet device, an E-book and a mobile multimedia device.

8. The remote-interaction apparatus according to claim 7, wherein the second communication protocol comprises one of a wireless communication protocol and an internet communication protocol.

9. An interaction unit configured for cooperating with a portable electronic device to construct a remote-interaction apparatus, the portable electronic device installing a specific software, and the interaction unit comprising:
a communication module configured for communicating with the portable electronic device by a first communication protocol;
an input interface configured for detecting a sensory information inputted by a user;
a response module configured for performing a response action according to a control command; and
a process unit configured for finding out a first interaction information corresponding to the sensory information from an interaction-mode database and employing the first communication protocol for transmitting the first interaction information to the portable electronic can employ the portable electronic device to transmit the first interaction information to a portable electronic device of another remote-interaction apparatus by a second communication protocol, the process unit being further configured for employing the first communication protocol to receive a second interaction information transmitted from the portable electronic device through the communication module, the second interaction information being provided from the said another remote-interaction apparatus, and the process unit being further configured for finding out the control command corresponding to the second interaction information from the interaction-mode database and transmitting the control command to the response module.

10. The interaction unit according to claim 9, wherein the response module comprises at least one of a light-emitting device, a display device, a sound-making device, a vibration device and an odor-diffusion device, and the response action comprises at least one of emitting light, displaying image, making sound, vibrating and diffusing odor.

11. The interaction unit according to claim 9, wherein the sensory information comprises at least one of action, body-temperature, sound, touch, response, taste and appearance of the user.

12. The interaction unit according to claim 9, wherein the communication module comprises at least one of a Universal Series Bus module, a RS232 module, a radio frequency transceiving module, a far infrared module, a wireless fidelity module, a Bluetooth module, a ZigBee module and a power line communication module.

13. The interaction unit according to claim 9, wherein the interaction unit further comprises a memory, and the interaction-mode database is stored in the memory.

14. The interaction unit according to claim 9, wherein the portable electronic device comprises one of a mobile phone, a personal digital assistant, a notebook computer, a netbook computer, a tablet computer, a mobile internet device, an E-book and a mobile multimedia device.

15. The interaction unit according to claim 9, wherein the second communication protocol comprises one of a wireless communication protocol and an internet communication protocol.
